(19) United States
(12) Patent Application Publication
(10) Pub. No.: US 2018/0348110 A1
(43) Pub. Date: Dec. 6, 2018

(54) METHOD FOR OPTIMIZING WATER FILTRATION MEDIA FORMULATION FOR A PURIFICATION SYSTEM

(71) Applicant: HYDROVIV, LLC, Washington, DC (US)

(72) Inventor: Eric George Roy, Washington, DC (US)

(73) Assignee: HYDROVIV, LLC, Washington, DC (US)

(21) Appl. No.: 15/612,262

(22) Filed: Jun. 2, 2017

(51) Int. Cl. G01N 15/08; C02F 1/00; G06Q 90/00

(52) U.S. Cl. CPC G01N 15/08; C02F 2101/103; G06Q 90/00; C02F 1/008

(57) ABSTRACT

This invention relates to an automatable method to rapidly assess individual water purification needs, and the system that can quickly optimize the filtration formulation. In this method, information from multiple sources is merged to create a composite functional requirement for the filtration needs. With a priori knowledge of filtration characteristics of various solid phase extraction media, an optimized formulation can be identified that fixes the problems associated with the point of use.

### BACKGROUND

### Field of the Invention

This invention relates in general to an automatable method for producing water filters that are optimized for a user's water.

### SUMMARY OF INVENTION

This invention relates to an automatable method to optimize water filtration media formulations for individual needs. In this method and system, problems or potential problems for point of use are determined by aggregating data from different sources (source water assessments, water treatment procedures, problems associated with the age of municipal and entity infrastructure, water quality test reports, and end user preferences). Once the problems or potential problems with the point of use are identified, an optimized blend or filtration media can be calculated, based a priori knowledge of filtration performance characteristic for individual filtration media. By precisely matching the filtration media blend to the functional requirements of the water, filtration performance, flow rate, and cartridge lifetime are optimized.

### DETAILED DESCRIPTIONS OF THE INVENTION

The first step of the method described here is to identify problems and potential problems with a point of use. All types of points of use are covered, including for example residential and commercial faucets, drinking fountains, bottle filling stations, and showers. All types of water problems are included, including for example the presence of toxic or otherwise undesirable substances including heavy metals (e.g. lead, arsenic, mercury, chromium), “hard water” minerals (e.g. calcium, magnesium), pesticides (e.g. malathion, atrazine, parathion), petroleum-based hydrocarbons (e.g. gasoline, diesel, benzene), volatile organic compounds (VOCs) (e.g. chloroform), pathogenic organisms (e.g. E. coli), or substances that affect a water's taste and odor (e.g. chlorine, chloramine, hydrogen sulfide).

Many types of information can be used to identify the presence of problems or potential problems with an entity's water, including for example information found in publicly available sources (e.g. source water assessments, Consumer Confidence Reports, water quality violation notices, and reports of contamination). Problems can also be identified by performing chemical testing of the specific point of use. Problems or potential problems also include user identified problems with their water, for example including problems with their water's taste & odor.

Once the problems or potential problems for the point of use are identified, filtration media are selected that have the ability to remove the substances responsible for the identified problems or potential problems. The filtration media can have a specific ability to remove a singular chemical or a non-specific ability to remove a broad range of substances. Any appropriate filtration media materials can be used, including for example size exclusion media or membranes, activated carbon, alumina, birm, bone char, KDF 55, KDF 85, ion exchange resin, zeolite, silica, or water softening resin. Any coating or treatment may also be applied to the filtration media to improve the performance of the media, including for example surface plasma treatment, heat treatments, chemical vapor deposition, pore size tuning, vacuum phase surface modifications.

If more than one type of filtration media are required to fix the identified problems or potential problems, they can be combined in such a way that the filtration performance is maximized. For example, if a particular type of filtration media performs better when a particular substance is absent, a different type of filtration media may be placed “upstream” to remove the interfering chemical. Conversely, if the performance of a type of filtration media is enhanced by the presence of another type of media, the two types of media may be blended together to achieve optimal performance.

All types of water filtration systems are utilized, including for example a single cartridge containing multiple types of filtration media or multiple filtration cartridges arranged in-line where water passes through each cartridge sequentially. All appropriate types of filtration cartridges are included, including for example a cartridge capable of holding granular filtration media and solid “blocks” of porous material that water flows through.

Those skilled in the art will see numerous applications for the above mentioned embodiments, particularly those where custom water purification needs are required.

In time there will be an inventory of optimized water filtration media formulations and it will not be necessary to create a unique filter cartridge formulation for each point of use. Rather, the needs for a particular point of use will be determined and checked against the inventory of optimized water filtration media formulations to find the one that may fit the particular point of use. If one of the formulations in the inventory does not fit then a further unique optimized water filtration media formulation will be created for that point of use. In this way, the method of optimizing water filtration media formulations for a filter becomes scalable and does not have to be done for each point of use but rather may be selected from an inventory of previous formulations.

### Examples

The advantages produced by the invention can be demonstrated using the following example where multiple points of use have drastically different problems with their water, and subsequently have very filtration needs.

The first point of use in this example is a residence in Washington, D.C. Using a municipally-supplied Consumer Confidence Report, it is learned that Washington, D.C. draws drinking water from the Potomac River, a river that, according to a source water assessment conducted by the State of Maryland, has historical problems with pesticide and industrial chemical runoff. Additionally, the municipality-supplied Consumer Confidence Report disclose that Atrazine (an agricultural herbicide), chromium 6 (an industrial waste), and lead were both detected in Washington, D.C. tap water. From the Consumer Confidence Report, it is also learned that unlike most of the country that uses chlorine as a disinfectant, Washington, D.C. uses chloramine as the primary disinfectant. Using municipal infrastructure reports, it was also learned that this particular point of use is served by a lead service line, and the customer reports that the plumbing is old, so it likely uses lead components. Using these sources of information, it is determined that a water filter optimized for this point of use would have formulated to emphasize lead, chromium 6, agricultural pesticides, and chloramine removal. A carbon block comprised of activated carbon, catalytic carbon, chromium 6 sorbent, and lead sorbent was custom-formulated for this point of use.

The second point of use in this example is a residence in Maine that draws its water from a private well. Building records show that this home was built new in 2014, so there is no risk of lead being leached from the plumbing. The customer reports that the well is not treated with chlorine, and the water has a strong rotten egg smell, and poor taste, which is indicative of hydrogen sulfide. Using these sources of information, it is determined that a water filter optimized for this point of use would be best served by having a high capacity for hydrogen sulfide, and a granular cartridge comprised of granulated activated charcoal and KDF 85 was custom-formulated for this point of use.

The third point of use in this example is a single-family residence in New York City. Using the Consumer Confidence Report supplied by the municipality, it is learned that New York City uses chlorine as a primary disinfectant, and that a high proportion of residences have high lead concentrations due to old lead-containing infrastructure. From building permits, it is learned that the service line for this residence is made of lead. Data from the Consumer Confidence Report indicate that there are no other major violations involving the municipal tap water. Using these information sources, it is determined that a water filter optimized for lead and chlorine is ideal, and a custom carbon block comprised of activated charcoal and lead sorbent was custom-formulated for this point of use.

1. A method of optimizing water filtration media formulation for a filter at an entities point of use consisting of determining the problems or potential problems with the entities water by utilizing at least one of the following criteria, reviewing publically available sources such as water assessments, consumer confidence reports, quality violation notices, reports of contamination, or performing chemical testing at the point of use; taking the identified problems at the entities point of use and selecting one or more of appropriate filtration media to remove the identified problems; determining, in light of the identified problems if more than one filter needs to be utilized in series because some filtration media does not work well with another required filtration media in the same filter; and further determining whether granular or porous block type of filtration media should be utilized in the filter.

2. The method of optimizing water filtration media formulation for a filter at an entities point of use as claimed in claim 1, wherein the identified problems consist of one or more of the following, heavy metals, hard water minerals, pesticides, petroleum based hydrocarbons, volatile organic compounds, pathogenic organisms, or substances that affect the waters taste and/or odor.

3. The method of optimizing water filtration media formulation for a filter at an entities point of use as claimed in claim 2, wherein the heavy metals are lead, arsenic, mercury and/or chromium.

4. The method of optimizing water filtration media formulation for a filter at an entities point of use as claimed in claim 2, wherein the hard water minerals consists of calcium and/or magnesium.

5. The method of optimizing water filtration media formulation for a filter at an entities point of use as claimed in claim 2, wherein the pesticides are malathion, atraziane, and/or parathion.

6. The method of optimizing water filtration media formulation for a filter at an entities point of use as claimed in claim 2, wherein the petroleum based hydrocarbons are gasoline, diesel and/or benzene.

7. The method of optimizing water filtration media formulation for a filter at an entities point of use as claimed in claim 2, wherein the volatile organic compounds are chloroform.

8. The method of optimizing water filtration media formulation for a filter at an entities point of use as claimed in claim 2, wherein the pathogenic organisms are E. coli.

9. The method of optimizing water filtration media formulation for a filter at an entities point of use as claimed in claim 2, wherein the substances that affect the waters taste or odor are chlorine, chloramines, and/or hydrogen sulfide.

10. The method of optimizing water filtration media formulation for a filter at an entities point of use as claimed in claim 1, wherein the appropriate filtration media is selected from one or more of the following: activated carbon, alumina, birm, bone char, KDF 55, KDF 85, ion exchange resin, zeolite, silica, or water softening resin.

11. The method of optimizing water filtration media formulation for a filter at an entities point of use as claimed in claim 1, wherein the performance of the appropriate filtration media can be improved by subjecting it to one or more of the following: surface plasma treatment, heat treatment, chemical vapor deposition, poor size tuning, or vapor phase surface modifications.

12. The method of optimizing water filtration media formulation for a filter at an entity's point of use as claimed in claim 1, wherein the requirements for that entity's point of use is compared against an inventory of other optimized formulations and if a match is found, then the formulation of that match is utilized for that entity's point of use.

13. The method of optimizing water filtration media formulation for a filter at an entity's point of use as claimed in claim 12 wherein if a match is not found in the inventory of other determined optimized formulations then a unique formulation for that particular point of use is created and put in the inventory.
